(19) United States
(12) Patent Application Publication
(10) Pub. No.: US 2002/0135724 A1
(43) Pub. Date: Sep. 26, 2002

(54) Multi-domain liquid crystal display with a structure of dielectric layers having inhomogeneous dielectric distribution

(76) Inventors: Ching-Yih Chen, Chung-Hua Lii (TW); Hong-Da Liu, Juipei City (TW)

Correspondence Address: Jason Z. Lin, 19597 Via Monte Drive, Saratoga, CA, 95070, US

(21) Appl. No.: 09/815,826

(22) Filed: Mar. 24, 2001

(51) Int. Cl. G02F 1/1337

(52) U.S. Cl. 349/129

(57) ABSTRACT

A multi-domain liquid crystal display has a structure of dielectric layers with inhomogeneous dielectric distribution. At least one dielectric layer is formed on an electrode layer of one substrate or both substrates. A predefined pattern is used for the dielectric layers to introduce an inhomogeneous dielectric distribution that generates lateral fringe field and changes the direction of the electric lines at the lateral fringe field on the electrode of a substrate. One of the electrode layers may be formed with bump structures or openings in combination with fringe field effect to provide pre-tilting of liquid crystals to enhance the effect of multiple domains and decrease the response time. The multi-domain liquid crystal display can be fabricated without requiring additional photo masks, ITO etching, bump formation or mask rubbing process.

### FIELD OF THE INVENTION

The present invention relates generally to a multi-domain liquid crystal display (MD-LCD), and more specifically to a multi-domain liquid crystal display with a structure of dielectric layers having inhomogeneous dielectric distribution.

### BACKGROUND OF THE INVENTION

In recent years, liquid crystal displays have become very popular in the market place. High quality liquid crystal displays require high resolution as well as a wide viewing angle. As a result, multi-domain liquid crystal displays have been developed to meet these requirements. In a multi-domain liquid crystal display, each pixel is divided into multiple domains to compensate for the asymmetry in optics to increase the viewing angle of the display.

Conventional multi-domain liquid crystal display technology can be divided into four categories. The first category uses transparent material to form protruded portions or bumps on a substrate to tilt vertically aligned liquid crystals along different directions when an electrical voltage is applied. Although this technique can pre-tilt liquid crystals without a mark rubbing or photo-aligned process, the alignment of liquid crystals are not very stable. It often requires other techniques to stabilize the multi-domain effect.

The second technique relies on slits or openings formed on an indium-tin-oxide (ITO) electrode layer by etching in cooperation with fringe field effect to form multiple domains similar to the first technique. In practice, the technique can be combined with the first technique to achieve better results. If the second technique is used alone, chiral dopants have to be added to the liquid crystals and the response time is slower. The third technique uses mask rubbing which is a very complicated process with low yield. The fourth technique relies on a photo-aligned method that is still immature.

Forming multiple domains of the conventional multi-domain twisted nematic thin film transistor liquid crystal displays requires complex process steps during manufacturing. For example, slits are etched or bumps are formed on indium-tin-oxide electrodes on color filter substrates, or bumps are formed on TFT substrates. These processes must consider the etching difficulty of indium-tin-oxide electrodes, the cooperation of the color filter supplier, and the material, the width and the shape of bumps. In addition, several rubbing process steps are required during the manufacturing. Both electric static damage (ESD) and prevention of particle contamination are issues that have to be resolved. At present, the technique of the photo-aligned method for the formation of multiple domains uses ultraviolet light or laser light as the light source to illuminate the alignment film so that liquid crystals have uniform orientation. However, multiple illumination steps are needed in the technique of the photo-aligned method to form multiple domains.

FIG. 1 shows an example of the conventional multi-domain vertically aligned liquid crystal display with bump structures. The multiple domains in the display are enhanced by means of fringe filed effect and bump structures formed on both upper and lower substrates. As illustrated by the cross-sectional view in FIG. 1, the liquid crystal display 100 comprises a liquid crystal layer sandwiched between two substrates. The lower substrate 108 is a thin film transistor substrate with a pixel electrode layer 105 formed thereon. The upper substrate 109 is a color filter substrate with a common electrode layer 106 formed underneath. Crossed polarizers 101 and 102 are attached to the exterior surfaces of the display. Compensation films 103 and 104 are placed between the two polarizers 101 and 102. As can be seen from FIG. 1, slot-shaped bumps 111-117 are formed in the common and pixel electrode layers.

The conventional technique of using transparent material to form bump structures for vertically aligned multi-domain liquid crystal display has another drawback that the bump structures comprise parallel walls which result in disclination lines in the transparent areas of the display. Furthermore, bump structures have to be formed on both upper and lower substrates of the display to ensure that liquid crystals are aligned stably in the multiple domains and avoid the drifting of optical textures. The alignment accuracy, however, may be a problem.

### SUMMARY OF THE INVENTION

This invention has been made to overcome the above-mentioned drawbacks of a conventional multi-domain liquid crystal display. The primary object is to provide a multi-domain liquid crystal display with a structure of dielectric layers having inhomogeneous dielectric distribution. The liquid crystal display comprises a first substrate, a second substrate and a liquid crystal layer being formed between the first and the second substrates. A pixel electrode layer is formed on the first substrate and a common electrode layer is formed underneath the second substrate. At least one dielectric layer is formed on the electrode layer of one or both of the first and second substrates. The structure of each dielectric layer has an inhomogeneous distribution of at least one dielectric coefficient.

According to the invention, the liquid crystal display uses a structure of dielectric layers with a predefined pattern to form an inhomogeneous dielectric distribution that generates lateral fringe field and changes the direction of the electric lines at the lateral fringe field on the slit electrode of a substrate. Because negative-typed liquid crystals need vertical electric lines, electric lines at the area having dielectric layers is more inclined than those at the area without dielectric layers after an electrical voltage is applied to the display. Therefore, enhanced inclining of liquid crystals is provided in different directions to form multiple domains and the response time is thus decreased.

Another object of the invention is to provide a manufacturing method for the multi-domain liquid crystal display with a structure of dielectric layers having inhomogeneous dielectric distribution. Accordingly, a first substrate having a pixel electrode layer formed thereon and a second substrate having a common electrode layer formed underneath are provided. At least one dielectric layer is formed on the electrode layer of one or both first and second substrates. A structure of dielectric layers is then fabricated according to a predefined pattern to introduce an inhomogeneous dielectric distribution of at least one dielectric coefficient.

According to the invention, the dielectric coefficients are determined by the horizontal and vertical dielectric coefficients of liquid crystals. The step of forming the structure of dielectric layers may be accomplished by etching, doping, implanting or diffusion method so that the structure of each dielectric layer has a predefined pattern and an inhomogeneous distribution of at least one dielectric coefficient.

In a preferred embodiment of the multi-domain liquid crystal display of the invention, the structure of dielectric layers may have different patterns. The structure of dielectric layers having inhomogeneous dielectric distribution may work with electrode openings or bump structures fabricated on one or both of upper and lower substrates in combination with fringe field effect to form multiple domains. In addition, the structure of dielectric layers having inhomogeneous dielectric distribution can be designed on a multi-domain liquid crystal display in which liquid crystal is vertically aligned, horizontally aligned, low pre-tilted with an angle or reversibly tilted with an angle.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of a conventional multi-domain vertically aligned liquid crystal display with bump structures.

FIG. 2 shows a cross-sectional view of a preferred embodiment of the multi-domain liquid crystal display with a structure of dielectric layers having inhomogeneous dielectric distribution according to the present invention.

FIG. 3a shows a cross-sectional view of a liquid crystal display in which a single dielectric layer with three dielectric regions having the same dielectric coefficient but different heights is formed on one substrate.

FIG. 3b shows a cross-sectional view of a liquid crystal display in which a single dielectric layer with three dielectric regions having the same dielectric coefficient but different widths is formed on one substrate.

FIG. 3c shows a cross-sectional view of a liquid crystal display in which two electrode layers having a passivation layer in between are formed on a substrate and a single dielectric layer with three dielectric regions having the same dielectric coefficient but different widths is formed above the upper electrode layer.

FIG. 3d shows a cross-sectional view of a liquid crystal display in which a single dielectric layer with dielectric regions having the same dielectric coefficient but different heights is formed on one substrate.

FIG. 3e shows a cross-sectional view of a liquid crystal display in which a single dielectric layer with sinusoidal dielectric regions having the same dielectric coefficient is formed on one substrate.

FIG. 3f shows a cross-sectional view of a liquid crystal display in which a single dielectric layer having regions of different dielectric coefficients is deposited on one substrate.

FIG. 4 shows a cross-sectional view of a liquid crystal display in which a dielectric layer having regions of different dielectric coefficients is deposited on each of upper and lower substrates according to the invention.

FIG. 5 shows the structure of a dielectric layer that is used in cooperation with the electrode openings on a substrate in the XY plane according to the invention.

FIG. 6 shows the structure of a dielectric layer that is used in cooperation with a wall-bump structure on a substrate in the XY plane according to the invention.

FIG. 7 shows the top views of four different structures of a dielectric layer in a pixel area according to the invention, and the four views have a shape of an X, a slanted slot, a rounded shape and a Y-inverse-Y shape respectively.

FIG. 8 shows the light distribution of liquid crystals in a liquid crystal display according to the invention by a side view in the z direction after an electrical voltage is applied to the display.

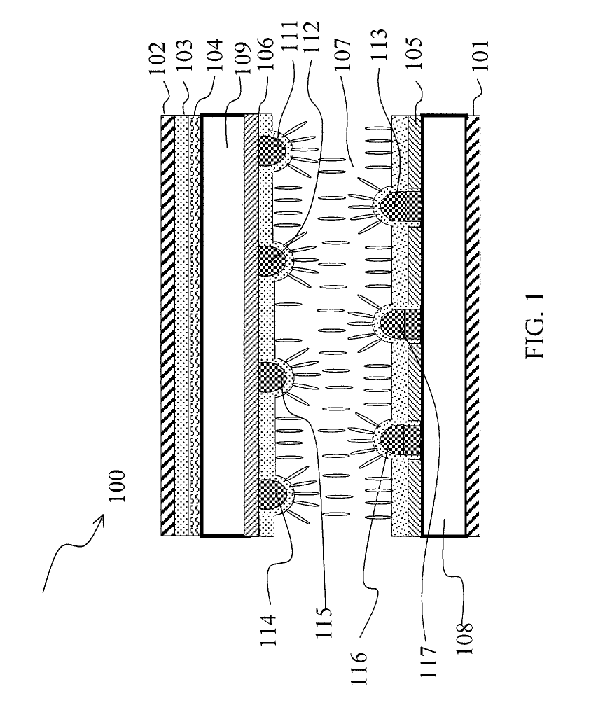

### DETAILED DESCRIPTION OF THE INVENTION

The primary operating principle of the multi-domain liquid crystal display of the invention is based on an inhomogeneous dielectric distribution introduced by a predefined structure of dielectric layers. The inhomogeneous distribution results in lateral fringe field and changes the direction of the electric lines at the lateral fringe field on the slit electrode of a substrate. Because negative-typed liquid crystals need vertical electric lines, electric lines at the area having dielectric layers are more inclined than those at the area without dielectric layers after an electrical voltage is applied to the display. Therefore, liquid crystals are inclined in different directions to form multiple domains and the response time is also decreased.

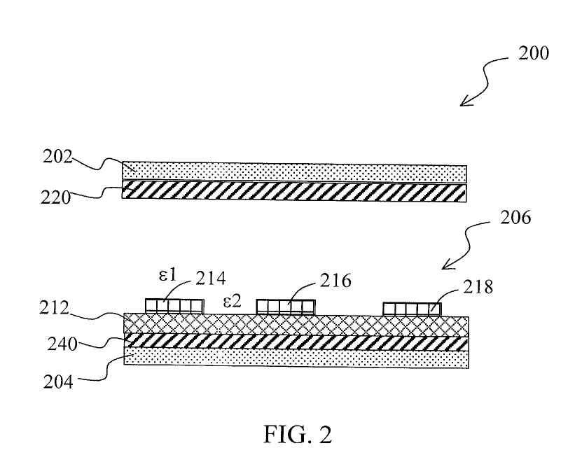

FIG. 2 shows a cross-sectional view of a preferred embodiment according to the present invention. In the embodiment, the structure of dielectric layers is formed on the top of a glass substrate. As shown in FIG. 2, the liquid crystal display 200 comprises an upper substrate 202, a lower substrate 204, and a liquid crystal layer 206 sandwiched between these two substrates. A pixel electrode layer 240, such as an ITO electrode layer, is formed on the lower substrate 204. A common electrode layer 220 is formed underneath the upper substrate 202.

According to this embodiment, the structure of dielectric layers is fabricated on the pixel electrode layer 240 by depositing a dielectric layer 212 with dielectric coefficient ε₁ and another dielectric layer with dielectric coefficient ε₂ to form three dielectric regions 214, 216 and 218. The dielectric coefficients ε₁ and ε₂ are determined respectively by the horizontal and vertical dielectric coefficients of liquid crystals. By means of the structure formed by the dielectric layer 212 and the plurality of dielectric regions, an inhomogeneous dielectric distribution is introduced to generate lateral fringe field that changes the direction of the electric lines. Because negative-typed liquid crystals need vertical electric lines, electric lines at the area having dielectric layers are more inclined than those at the area without dielectric layers after an electrical voltage is applied to the display. Therefore, liquid crystals are inclined in different directions to form multiple domains and the response time is also decreased.

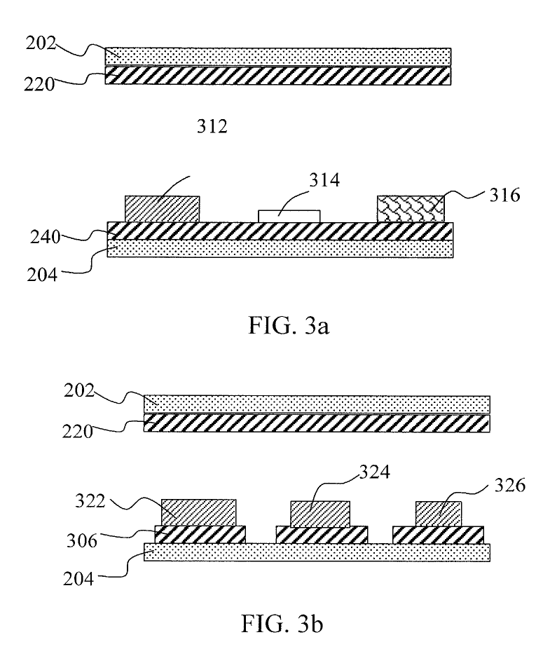

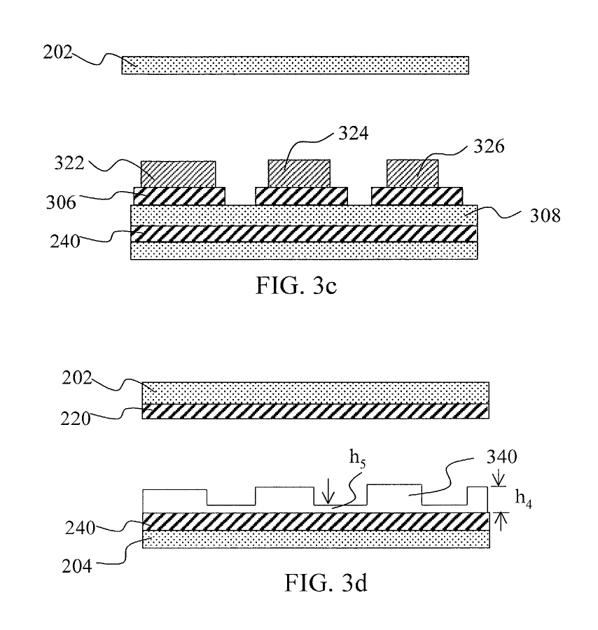

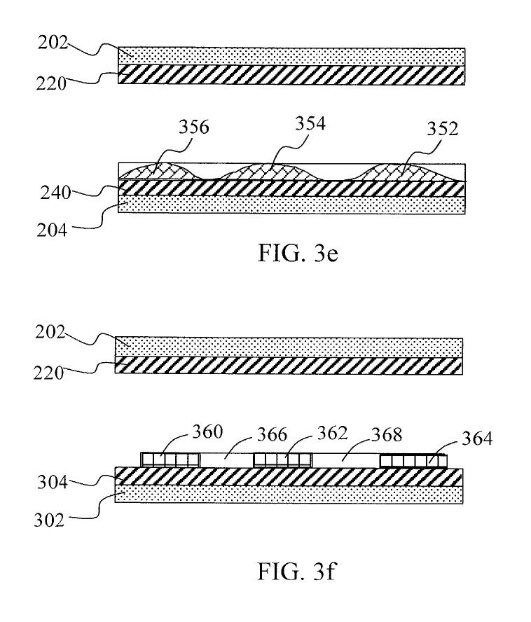

In the present invention, the structure of dielectric layers may have different patterns and can be fabricated on one substrate or on both upper and lower substrates. FIGS. 3a-3f illustrate the cross-sectional views of different patterns for the structure of dielectric layers in which some are formed on a single substrate. A single dielectric layer of a same dielectric coefficient may be deposited on one substrate to form dielectric regions of various heights, widths, or shapes. A dielectric layer having different dielectric coefficients may also be deposited to form various dielectric regions.

FIG. 3a shows two electrode layers 220 and 240 that are formed underneath the upper substrate 202 and above the lower substrate 204 respectively. A dielectric layer of dielectric coefficient ε is deposited on the pixel electrode layer 240. This dielectric layer comprises three dielectric regions 312, 314 and 316 of different heights h₁, h₂ and h₃ respectively. FIG. 3b shows that a single dielectric layer of dielectric coefficient ε is deposited on the pixel electrode layer 306 on the lower substrate 204. This dielectric layer comprises three dielectric regions 322, 324 and 326 of different widths w₁, w₂ and w₃ respectively.

FIG. 3c shows a structure similar to that shown in FIG. 3b except that there are two electrode layers 240 and 306 formed on the lower substrate 204. A passivation layer 308 is sandwiched between the electrode layers 240 and 306. FIG. 3d shows that a dielectric layer 340 of dielectric coefficient ε is deposited on the pixel electrode layer 240 above the lower substrate 204. This dielectric layer 340 comprises dielectric regions of different heights h₄ and h₅.

FIG. 3e shows that a dielectric layer of dielectric coefficient ε is deposited on the pixel electrode layer 240 above the lower substrate 204. This dielectric layer comprises three sinusoidal dielectric regions 352, 354 and 356. In practice, the heights and widths of the above-mentioned dielectric regions can be the same or different. FIG. 3f shows that a dielectric layer of two dielectric coefficients ε₁ and ε₂ is deposited on the pixel electrode layer 304 above the lower substrate 302. This dielectric layer comprises dielectric regions 360, 362 and 364 of dielectric coefficient ε₁ as well as dielectric regions 366 and 368 of dielectric coefficient ε₂.

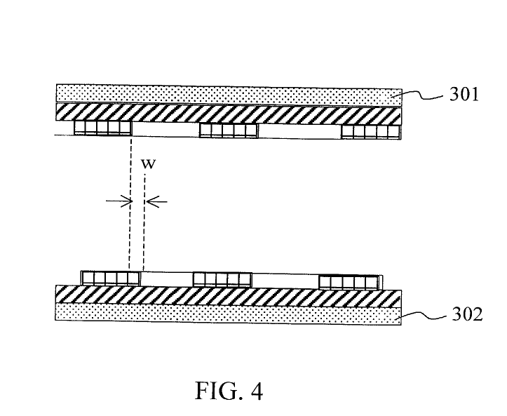

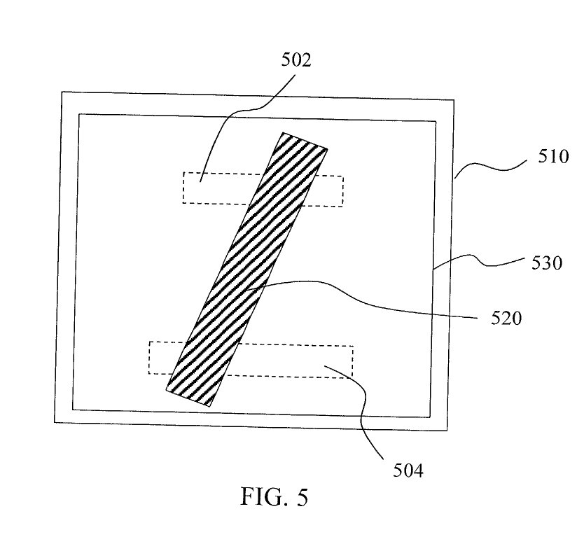

According to the invention, the formation of dielectric layers can be accomplished by etching, doping, implanting or diffusion methods so that the structure of each dielectric layer has a predefined pattern with an inhomogeneous distribution of at least one dielectric coefficient. The preferred height for a dielectric layer is between 100 angstroms (A) to ⅕ of the cell gap of liquid crystals. The structure of dielectric layers with the above-mentioned patterns can be fabricated on one or both of upper and lower substrates. FIG. 4 shows that a dielectric layer as depicted in FIG. 3f has been duplicated and deposited on both upper and lower substrates 301 and 302. As illustrated by the cross-sectional view in FIG. 4, there is a horizontal displacement w between the structure of the dielectric layer underneath the upper substrate 301 and the structure of the dielectric layer on the lower substrate 302.

Moreover, the structure of dielectric layers having inhomogeneous dielectric distribution may work in cooperation with electrode openings formed or bump structures fabricated on one substrate or both upper and lower substrates as well as in combination with fringe filed effect to pre-tilt liquid crystals and form multiple domains in a liquid crystal display. FIG. 5 shows the structure of a dielectric layer having inhomogeneous dielectric distribution designed to work with electrode openings on a substrate in the XY plane according to the present invention. Two dielectric regions 520 and 530 of respective dielectric coefficients ε₁ and ε₂ are deposited on the electrode layer 510 that has two slot-shaped openings 502 and 504 thereon.

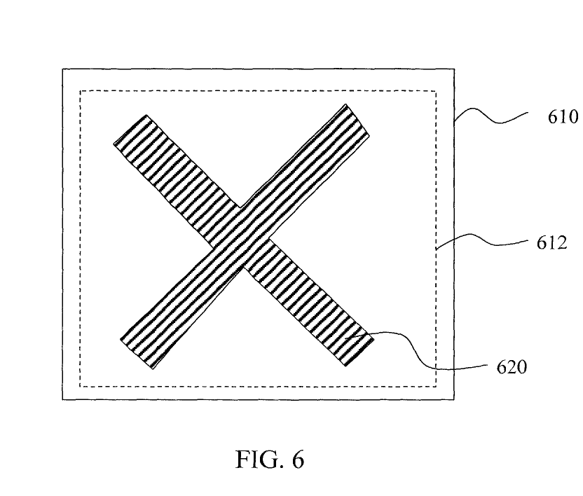

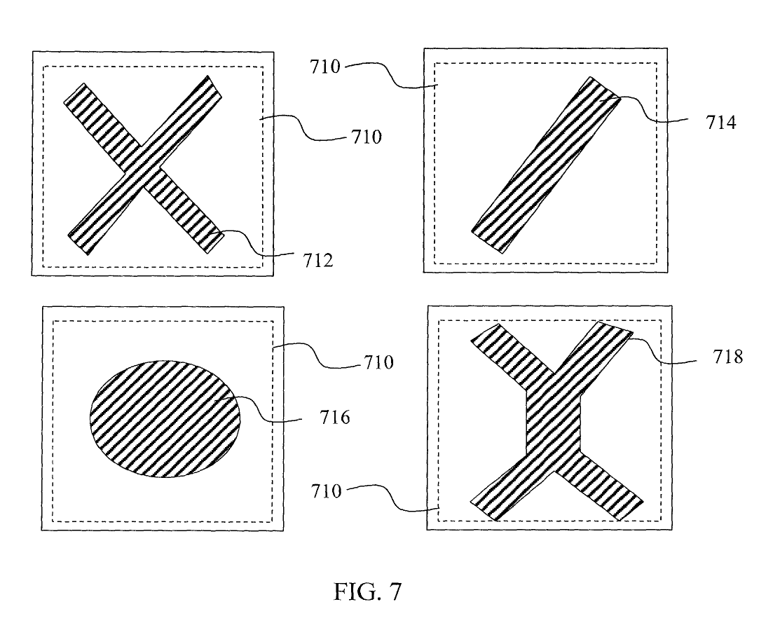

FIG. 6 shows the structure of a dielectric layer having inhomogeneous dielectric distribution designed to work with a wall-bump structure on a substrate in the XY plane according to the invention. A dielectric region 620 of dielectric coefficient ε₁ works with a wall-bump structure 612 around a pixel area 610. In practice, the top view of the structure of a dielectric layer may have a shape selected from the group of a horizontal slot, a cross, an X shape, a Y-inverse-Y shape, a vertical slot, or a combination of these shapes according to the invention. FIG. 7 shows the top views of four structures of a dielectric layer having a shape of an X 712, a slanted slot 714, a rounded shape 716 and a Y-inverse-Y shape 718 in a pixel area 710 respectively.

In addition to working with electrode openings or bump structures in combination with fringe filed effect, the structure of dielectric layers having inhomogeneous dielectric distribution can be designed on a multi-domain liquid crystal display with liquid crystals that are vertically aligned, horizontally aligned, low pre-tilted with an angle or reversibly tilted with an angle.

In the above-mentioned embodiments, the two substrates may be fabricated with thin-film transistors as the switching devices. The substrates may also comprise color filters. Alignment films of different types may be included in the display. In an embodiment, an alignment film for a horizontal direction or low pre-tilted angle may be included in the upper substrate layer and an alignment film for a vertical direction may be included in the lower substrate layer. The materials used in the alignment film include polyamic acid, polymide, PVC series and polysiloxane. If a photo-aligned method is used in the liquid crystal display, the alignment in the horizontal direction, vertical direction or low pre-tilted angle can be accomplished by controlling the illumination in the process.

The fabrication process for the structure of dielectric layers having inhomogeneous dielectric distribution comprises the following steps: (a) providing a first substrate and a second substrate such that the first substrate has a pixel electrode layer formed thereon and the second substrate has a common electrode layer formed underneath, (b) providing a predefined pattern and forming at least one dielectric layer on the electrode layer of one or both first and second substrates, and (c) forming a structure of dielectric layers according to the predefined pattern so that each structure has an inhomogeneous distribution of at least one dielectric coefficient.

In step (c), the dielectric layers can be formed by etching, doping, implanting or diffusion methods as mentioned before. Comparing to the fabrication process of a conventional multi-domain liquid crystal display, the process of this invention is very simple. It does not require additional photo masks, ITO etching, bump formation or mask rubbing processes.

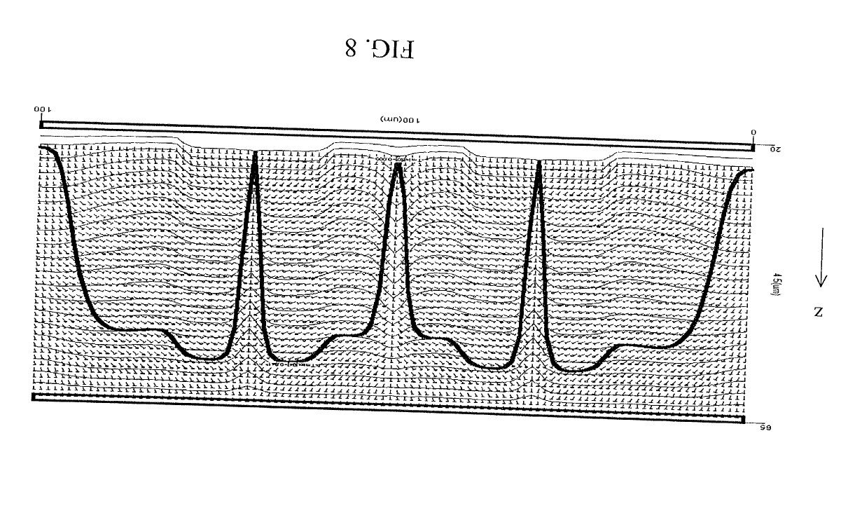

FIG. 8 shows the domain divided effect on the liquid crystals after an electrical voltage is applied to the display according to this invention. As illustrated by a side view in z direction in FIG. 8, the structure of FIG. 3f is simulated. The display has one dielectric layer that comprises two dielectric regions. One dielectric region has a width of 20 μm, a height of 3000 angstroms and a dielectric coefficient of 7. The other dielectric region has a dielectric coefficient of 2. The cell gap of liquid crystals is 4 μm, and the applied voltage is 4 volt. As shown in FIG. 8, the liquid crystals above the dielectric region of dielectric coefficient 7 are inclined toward the center of the dielectric region. While the liquid crystals above the dielectric region of dielectric coefficient 2 are inclined away from the center of the dielectric region. The liquid crystals incline very fast after an electrical voltage is applied.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

Whis is claimed is:

1. A multi-domain liquid crystal display comprising:
a first substrate;
a second substrate;
a layer of liquid crystal cells formed between said first and said second substrates;
a pixel electrode layer formed on said first substrate;
a common electrode layer formed underneath said second substrate; and
at least one dielectric layer formed on said electrode layer of one or both of said first and second substrates, said dielectric layer having an inhomogeneous dielectric distribution of at least one dielectric coefficient in a pixel area.

2. The multi-domain liquid crystal display as claimed in claim 1, wherein a predefined pattern is used to form at least one dielectric layer with at least one dielectric region having a distribution of at least one dielectric coefficient in a pixel area.

3. The multi-domain liquid crystal display as claimed in claim 1, wherein at least one dielectric layer comprises a plurality of dielectric regions of different heights in a pixel area.

4. The multi-domain liquid crystal display as claimed in claim 1, wherein at least one dielectric layer comprises a plurality of dielectric regions of same heights in a pixel area.

5. The multi-domain liquid crystal display as claimed in claim 1, wherein at least one dielectric layer comprises a plurality of dielectric regions of different widths in a pixel area.

6. The multi-domain liquid crystal display as claimed in claim 1, wherein at least one dielectric layer comprises a plurality of dielectric regions of same widths in a pixel area.

7. The multi-domain liquid crystal display as claimed in claim 1, said at least one dielectric layer comprises a plurality of dielectric regions of different shapes in a pixel area.

8. The multi-domain liquid crystal display as claimed in claim 1, said first substrate being a thin-film transistor substrate.

9. The multi-domain liquid crystal display as claimed in claim 1, said second substrate being a color filter substrate.

10. The multi-domain liquid crystal display as claimed in claim 1, said pixel electrode layer comprising at least one opening in a pixel area.

11. The multi-domain liquid crystal display as claimed in claim 1, said common electrode layer comprising at least one opening in a pixel area.

12. The multi-domain liquid crystal display as claimed in claim 1, wherein the height of said at least one dielectric layer ranges from 100 angstroms to 115 of the cell gap of liquid crystal cells.

13. The multi-domain liquid crystal display as claimed in claim 1, said pixel electrode layer comprising a wall-bump structure having a plurality of wall-bumps surrounding a pixel electrode in a pixel area.

14. The multi-domain liquid crystal display as claimed in claim 1, said liquid crystal cells being vertically aligned.

15. The multi-domain liquid crystal display as claimed in claim 1, said liquid crystal cells being horizontally aligned.

16. The multi-domain liquid crystal display as claimed in claim 1, said liquid crystal cells being low pre-tilted with an angle.

17. The multi-domain liquid crystal display as claimed in claim 1, said liquid crystal cells being reversibly tilted with an angle.

18. A multi-domain liquid crystal display comprising:
a first substrate;
a second substrate,
a pixel electrode layer formed on said first substrate;
a passivation layer formed on said pixel electrode layer;
a common electrode layer formed on said first substrate and said passivation layer;
at least one dielectric layer formed on said common electrode layer, said dielectric layer having an inhomogeneous dielectric distribution of at least one dielectric coefficient in a pixel area; and
a layer of liquid crystal cells formed between said first and said second substrates.

19. The multi-domain liquid crystal display as claimed in claim 18, said pixel electrode layer comprising at least one opening in a pixel area.

20. The multi-domain liquid crystal display as claimed in claim 18, said pixel electrode layer comprising a wall-bump structure having a plurality of wall-bumps surrounding a pixel electrode in a pixel area.

21. The multi-domain liquid crystal display as claimed in claim 18, said common electrode layer comprising at least one opening in a pixel area.

22. A method for manufacturing a multi-domain liquid crystal display, said method comprising the steps of:
(a) providing a first substrate and a second substrate, said first substrate having a pixel electrode layer formed thereon and said second substrate having a common electrode layer formed underneath;
(b) depositing at least one dielectric layer on said electrode layer of one or both of said first and second substrates; and
(c) forming a structure of at least one dielectric layer according to a predefined pattern for introducing an inhomogeneous dielectric distribution of at least one dielectric coefficient.

23. The method for manufacturing a multi-domain liquid crystal display as claimed in claim 22, wherein in said step (c), said at least one dielectric layer is etched to form said structure of at least one dielectric layer for introducing an inhomogeneous dielectric distribution of at least one dielectric coefficient according to said predefined pattern.

24. The method for manufacturing a multi-domain liquid crystal display as claimed in claim 22, wherein in said step (c), said at least one dielectric layer is doped to form said structure of at least one dielectric layer for introducing an inhomogeneous dielectric distribution of at least one dielectric coefficient according to said predefined pattern.

25. The method for manufacturing a multi-domain liquid crystal display as claimed in claim 22, wherein in said step (c), said at least one dielectric layer is implanted to form said structure of at least one dielectric layer for introducing an inhomogeneous dielectric distribution of at least one dielectric coefficient according to said predefined pattern.

26. The method for manufacturing a multi-domain liquid crystal display as claimed in claim 22, wherein in said step (c), said at least one dielectric layer is diffused to form said structure of at least one dielectric layer for introducing an inhomogeneous dielectric distribution of at least one dielectric coefficient according to said predefined pattern.
